(19) United States
(12) Patent Application Publication
(10) Pub. No.: US 2011/0202654 A1
(43) Pub. Date: Aug. 18, 2011

(54) CONFIGURABLE CONTENT INJECTION SERVICE SYSTEM

(75) Inventors: Paul Marquess, Belfast (GB); Stephen F. Wright, Belfast (GB)

(73) Assignee: OPENWAVE SYSTEMS INC., Redwood City, CA (US)

(21) Appl. No.: 13/027,601

(22) Filed: Feb. 15, 2011

Related U.S. Application Data
(60) Provisional application No. 61/304,790, filed on Feb. 15, 2010.

(51) Int. Cl. G06F 15/173

(52) U.S. Cl. 709/224

(57) ABSTRACT

A configurable content injection service system and method of injecting a new content into data of a data traffic between a data source and a user device uses configuration information set by one or more content injection service users. The configuration information includes at least one condition related to the data traffic between the data source and the user device to inject the new content if the at least one condition is satisfied.

### CROSS-REFERENCE TO RELATED APPLICATION

This application is entitled to the benefit of provisional U.S. Patent Application Ser. No. 61/304,790, filed Feb. 15, 2010, which is incorporated herein by reference.

### BACKGROUND OF THE INVENTION

In a conventional networked environment, networks may be computer networks, telecommunication networks, broadcast communication networks, switched communication networks or fully connected networks. There are typically two types of communications, which may be considered client-server communications or peer-to-peer communications. In any networked environment, at least one networked device is a supplier of resources and at least one is a consumer of resources. The supplier of resources may send the resources to the consumer of the resources, which may or may not be in response to the consumer of the resources sending a request for resources. However, there is a need for a system to alter these resources in certain circumstances after the resources have been sent by the supplier of the resources.

### SUMMARY

A configurable content injection service system and method of injecting a new content into data of a data traffic between a data source and a user device uses configuration information set by one or more content injection service users. The configuration information includes at least one condition related to the data traffic between the data source and the user device to inject the new content if the at least one condition is satisfied.

A content injection service system in accordance with an embodiment of the invention comprises a configuration module configured to enable content injection service users to set configuration information, the configuration information including at least one condition related to data traffic between a data source and a user device, a management module configured to monitor data of the data traffic, the management module further configured to determine if the at least one condition is satisfied, and a content injector operatively connected to the management module, the content injector configured to inject a new content into the data in response to the at least one condition being satisfied such that the data and the new content are transmitted to the user device if the at least one condition is satisfied.

A content injection service system in accordance with another embodiment of the invention comprises a configuration module configured to enable content injection service users to set configuration information, the configuration information including at least one condition related to data files being transmitted between a data source and a user device, a management module configured to monitor the data files being transmitted between the data source and the user device, the management module further configured to determine if the at least one condition is satisfied, and a content injector operatively connected to the management module, the content injector configured to inject a script into at least some of the data files in response to the at least one condition being satisfied such that the at least some of the data files with the script are transmitted to the user device if the at least one condition is satisfied.

A method of injecting a new content into data of a data traffic between a data source and a user device in accordance with an embodiment of the invention comprises receiving configuration information configured by a content injection service user, said configuration information including at least one condition related to said data traffic between said data source and said user device, receiving said data being transmitted from said data source to said user device, determining if said at least one condition is satisfied, injecting said new content into said data if said at least one condition is satisfied, and sending said data including said new content to said user device if said at least one condition is satisfied.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a content injection service in a networked environment in accordance with an embodiment of the invention.

FIG. 2 is a diagram of a content injection service environment in accordance with another embodiment of the invention.

FIG. 3 is a diagram of a content injection service environment with a proxy in accordance with another embodiment of the invention.

FIG. 4 is a flowchart of a method for providing a configurable injection service in accordance with an embodiment of the invention.

FIG. 5 is a flowchart of a method for providing a configurable injection service in accordance with another embodiment of the invention.

FIG. 6 is a flowchart of a method for allowing a content injection service user to control content injection in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

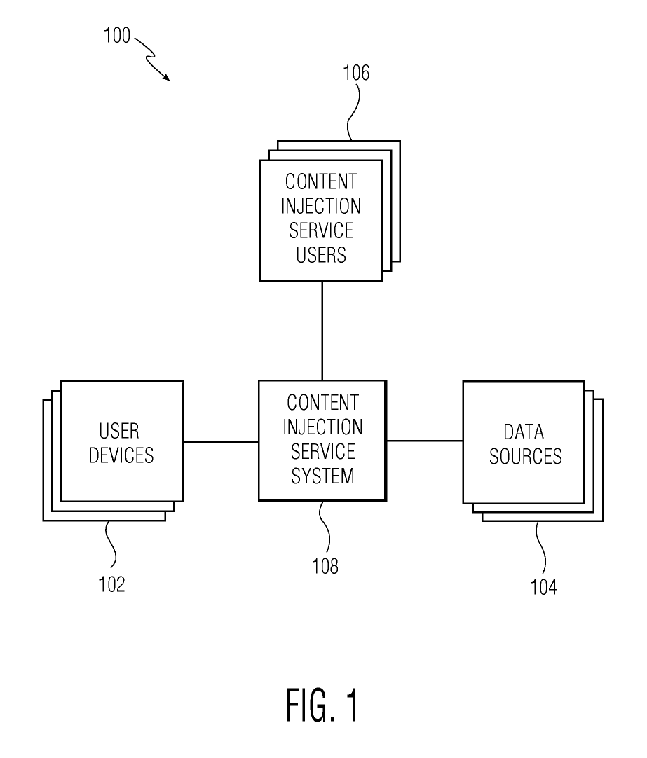

With reference to FIG. 1, a content injection service in a networked environment 100 in accordance with an embodiment of the invention is shown. As described in more detail below, the content injection service in a networked environment 100 comprises user devices 102, data sources 104, content injection service users 106, and content injection service system 108.

In the example of FIG. 1, the content injection service system 108 is located between the data sources 104 and the user devices 102 in the networked environment 100. Communication between networked devices may be carried out using a communication interface, such as analog modem, ISDN modem or terminal adapter, cable modem, Ethernet/IEEE 802.3 interface, wireless 802.11 interface, WiMAX/IEEE 802.16 interface, Bluetooth interface, cellular/mobile phone interface, general packet radio service (GPRS) interface, Enhanced GPRS (EDGE/EGPRS), third generation (3G) mobile phone interface, High-Speed Packet Access (HSDPA/HSUPA/EUL) interface, Evolution-Data Optimized (EVDO) interface, code division multiple access (CDMA) interface, other interfaces for communicating between networked devices, or any combination thereof.

The content injection service system 108 may be a stand-alone hardware device, a hardware and/or software component of a stand-alone device, part of a proxy, or may be anywhere within at least one communication path between a user device and a data source. The content injection service users 106 can configure the content injection service system and set conditions for data traffic passing through the content injection service system. The content injection service users may register with the content injection service system and create configuration information. In one embodiment, the configuration information may include actions and conditions, whereby the actions will be carried out by the content injection service system on data in the data traffic if certain, or in some cases all conditions are met. In some embodiments, the content injection service system is configured such that the content injection service users may introduce, alter or modify the configuration information at any time after deployment of the content injection service system or after the content injection service system begins operation.

The content injection service system 108 injects content into data in a data path between a data source and a user device. The injection is based on the conditions set by the content injection service users 106 during configuration of the content injection system, and/or based on parameters deduced by the content injection service system from the conditions. The content injection service users may choose the type of content to be injected, the place the content is injected within data in the data traffic, and/or when the injection is to be carried out.

In the example of FIG. 1, the communication between the user devices 102 and the data sources 104 may be any type of network communication, such as client-server communication or peer-to-peer communication. Client-server communications may, for example, use protocols such as Hypertext Transfer Protocol (HTTP), Simple Mail Transfer Protocol (SMTP), or Telnet. Examples of peer-to-peer communications may be Short Message Services (SMS) or Instant Messages (IM). In one embodiment, the data source may be another user device. In a non-limiting example, the content injection service user may be an application.

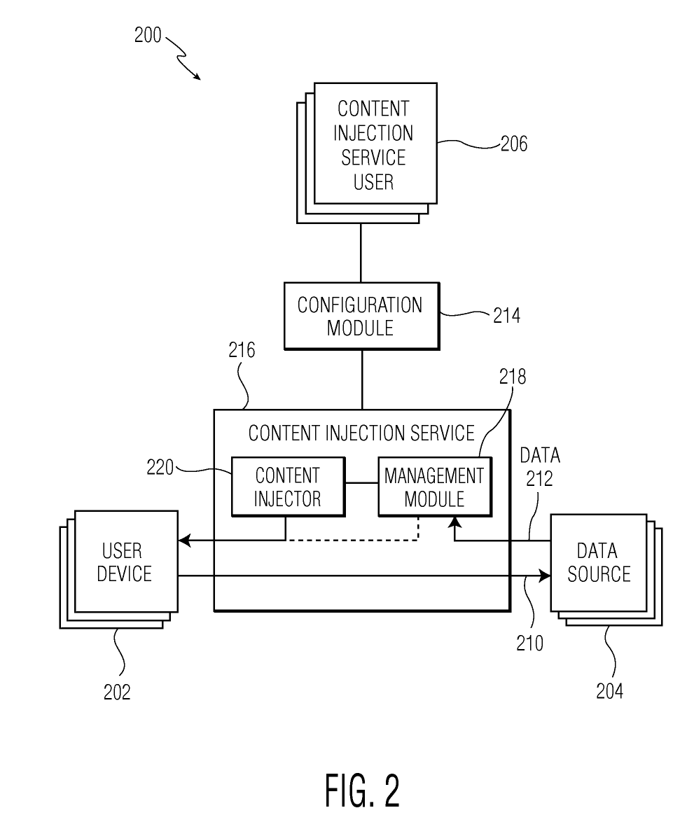

Turning now to FIG. 2, a content injection service environment 200 in accordance with another embodiment of the invention is shown. As shown in FIG. 2, the content injection service environment includes user devices 202, data sources 204, content injection service users 206, configuration module 214, and content injection service 216. The content injection service lies within the communication path of the data sources and the user devices. The content injection service can be, in a non-limiting example, implemented in a proxy server or a network device that operates at the HTTP layer and supports deep-packet inspection (DPI). In one exemplary embodiment, the configuration module may be accessed by an interface, such as a website, or an application, such as a web browser, enabling the content injection service user to configure the content injection service, as will be described in more detail below. The configuration module may be configured to receive and store configuration information set by the content injection service users to be used by the content injection service 216. In some embodiments, the configuration module may provide maintenance services for the content injection service 216. The configuration module may be implemented as software executed by a processor of any type, hardware, firmware or any combination thereof. The processor may be a general-purpose digital processor such as a microprocessor or microcontroller. In other embodiments, the processor may be a special-purpose processor such as a digital signal processor. In still other embodiments, the processor may be another type of controller or a field programmable gate array (FPGA). It will be appreciated that the configuration module may be considered to be part of the content injection service 216. The example of FIG. 2 may be applied to any client-server communication or any peer-to-peer communication. In the case of peer-to-peer communication, only the communication path between the data source and the user device may be present, such as when the data source transmits an SMS or instant message to the user device.

In the example of FIG. 2, the content injection service 216 comprises a management module 218 and a content injector 220. The management module is positioned in the communication path 212 of the data source, and intercepts content sent by the data source. The content injection service users 206 can dynamically add injection service instances to the management module either directly or indirectly through the configuration module 214. In the case where the injection service instances are added to the management module through the configuration module 214, the content injection service users can register the service instances with the configuration module. The management module may fetch or receive information stored in the service instances from the configuration module. The management module and the content injector may be implemented as software executed by a processor of any type, hardware, firmware or any combination thereof. The processor may be a general-purpose digital processor such as a microprocessor or microcontroller. In other embodiments, the processor may be a special-purpose processor such as a digital signal processor. In still other embodiments, the processor may be another type of controller or a FPGA.

In one embodiment, a service instance may include configuration information. The configuration information enables the management module 218 to determine what content to inject and under what circumstances to inject the content. The management module is configured to monitor data traffic to determine if conditions given by the configuration information are met. The content injector is configured to inject content, as determined by the configuration information, if the management module determines that one or more conditions given by the configuration information are met. In some cases, all conditions have to be met for the content injector service to inject content into data, whereas in other cases only some of the conditions have to be met.

In one embodiment, the content injection service 216 intercepts both the communication path 210 and the communication path 212 to determine whether the conditions are met and to inject the content if the conditions are met. In another embodiment, the content injection service monitors only the communication path 212.

In one embodiment, the configuration information includes information such as the Universal Resource Locator (URL) of the data source 204, the Internet Protocol (IP) address of the user device 202 and/or the data source, subscription information related to the user device, a class of service (subscription plan) of the user device, or times when a particular content injection should be applied.

In one embodiment, the data source 204 may send data in response to a data request from the user device 202. The management module 218 intercepts the data and determines whether conditions of one or more service instances are met. If conditions of a particular service instance are met or satisfied, the content injector 220 injects a new content into the data, whereby the new content is given by or can be deduced from the configuration information of the particular service instance. It is also possible that conditions of more than one service instance are met at the same time, in which case the content injection service may give priority to one service instance over the other, or apply content injection for both service instances simultaneously.

In an exemplary embodiment, the original content of the content response may be any data suitable to be transferred in a networked environment, such as markup language files, scripting language files, video files, music files, image files or other data files. In a non-limiting example, the original content may be an HTML file. The new content may be injected into the original file, or may be sent along with the original file. The new content may, for example, be a scripting language characters such as JavaScript, markup language characters such as HTML characters or segments, video file, music file, image file, or any combination thereof.

In one embodiment, the content injection service user 206 may choose one or more of the following exemplary parameters to set conditions: target user device (e.g. handheld, laptop, desktop); time and/or date; subscription status of user of the user device (could be determined via IP address of user device, or via authentication); URL of the content request.

In an illustrative, non-limiting example, a content injection service user 206 may choose to enable content injection only if the user device 202 is a handheld device, and only at weekends. In another non-limiting example the conditions may be chosen to inject content if the data source, to which the data request is directed to, has a particular URL. The type of new content to be injected can depend on the conditions that are satisfied, whereby if one set of conditions are satisfied, the content injection service injects a first new content into the original content, whereas if another set of conditions are satisfied, the content injection system injects a different new content. For example, the content injection service user may wish to inject a script into the original content that opens a popup window upon execution if the user device is a desktop, but the content injection user may wish to inject a script inserting a banner into the executed original content if the user device is a handheld device.

In another illustrative, non-limiting example, the injected content is a script or snippet of a markup language, which is inserted into the text of a markup language file at a particular position in the text. The particular position is given by or can be deduced from the configuration information of the service instance that applies. In one embodiment, if the conditions are not met or satisfied, the original data from the data source 204 is forwarded to the user device 202. In the case where only some conditions are met, but where the service instance requires that all conditions have to be met to inject a new content, the data is also not modified.

In the example of FIG. 2, the injected content may have different effects on the content perceived by the user device 202 compared to the original content sent by the data source 204. The new content may add content to the original content or change parts or all of the original content. In a non-limiting example, intended to be illustrative, the injected content has the effect of adding a right-click menu to images on an HTML page. In another example, the injected content may have the effect of adding a toolbar to the original content. In yet another example, the injected content inserts advertisement into the original content, such as for example banner ads on a webpage, or advertisement interruptions in a video stream. The advertisement may be tailored towards the user of the user device as determined by the configuration information provided by the content injection user.

The content injection user 206 may be any user that is allowed to use the content injection service 216 and may be the operator of the data source 204, a third party that does not own the data source or uses the user device 202, or a user of the user device. In a non-limiting example, the content injection service user may be the owner of a website to which the user device requests access. The content injection service user may be required to register with the content injection service prior to the content injection service user being able to configure service instances.

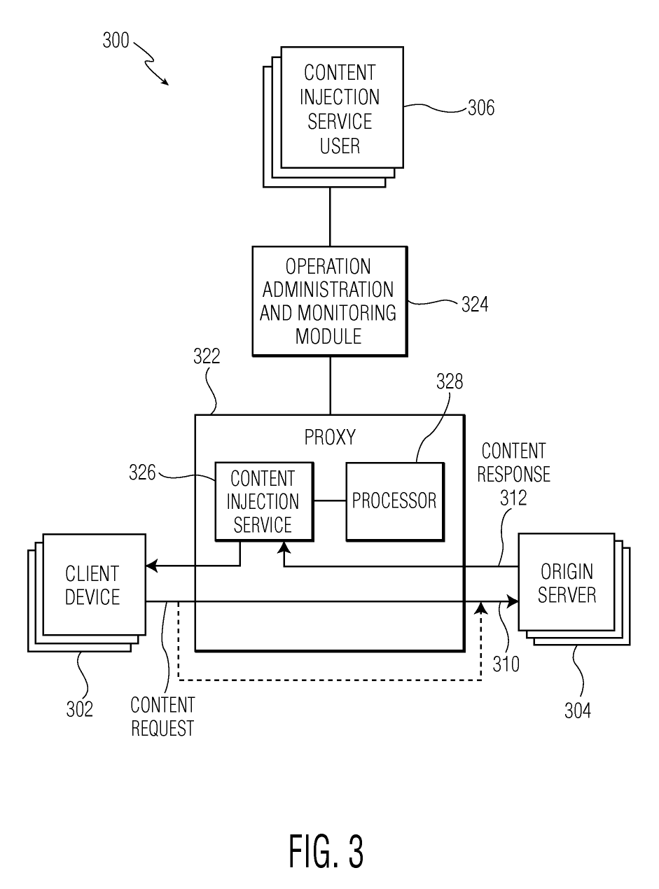

Turning now to FIG. 3, a content injection service environment 300 with a proxy 322 in accordance with another embodiment of the invention is shown. As shown in FIG. 3, the content injection service environment includes client devices 302, origin servers 304, content injection service users 306, operation administration and monitoring module 324, the proxy 322, and content injection service 326. It will be appreciated that the operation administration and monitoring module may be considered to be part of the proxy 322, which may be an Internet proxy. In one embodiment, the proxy 322 is an HTTP proxy server such as an Openwave® Integra, which is provided by Openwave Systems Inc. In one exemplary embodiment, the operation administration and monitoring module may be accessed by an interface, such as a website, or an application, such as a web browser, enabling the content injection service user to configure the content injection service.

In the example of FIG. 3, the content injection service 326 is part of the proxy 322 and lies within the response path 312 of communication between the user device 302 and the origin server 304 to intercept a content response. The content injection service 326 is similar to the content injection service 216, and thus, includes the management module 218 and the content injector 220. In an embodiment, the management module of the content injection service 322 may be a plan management module of the proxy. The proxy may be implemented as software executed by a processor of any type, hardware, firmware or any combination thereof. In some embodiments, the proxy includes at least one processor 328, which executes the functions of the content injection service 326, including the functions of the management module and the content injector of the content injection service 326. The processor may be a general-purpose digital processor such as a microprocessor or microcontroller. In other embodiments, the processor may be a special-purpose processor such as a digital signal processor. In still other embodiments, the processor may be another type of controller or a FPGA.

In the content injection service environment 300, a user device may send a content request to an origin server. This content request may or may not go through the content injection service 322. A content request may be any network request, such as HTTP or SMTP, and may request specific data such as HTML files. In response to the content request, the origin server may send a content response. Similar to the content injection service described with reference to FIG. 2, the content injection service 326 may inject content into an original content of the content response if certain conditions are satisfied. The conditions are customizable and can be dynamically set by a content injection user.

In the example of FIG. 3, the content injection service 322 may intercept the content response from the origin server to determine whether a new content should be injected into the original content of the content response. In another embodiment, the content injection service may also or alternatively intercept the content request on the request path 310 between the client device and the origin server. The content injection service may also inject content into the content request in addition or alternatively to injecting content into the content response. Although the example of FIG. 3 describes communication between a client device and an origin server, the same principles of FIG. 3 may also be applied to communications between any user device and data source, as discussed with reference to FIGS. 1 and 2.

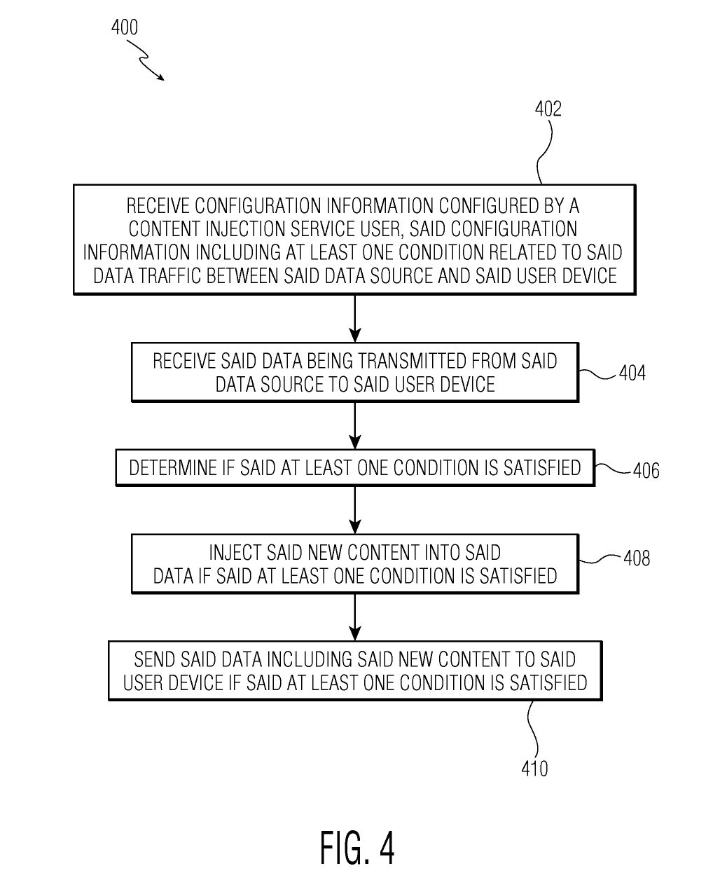

A method for injecting a new content into data of a data traffic between a data source and a user device in accordance with an embodiment of the invention is now described with reference to a flow diagram of FIG. 4. At block 402, configuration information configured by a content injection service user is received. The configuration information includes at least one condition related to the data traffic between the data source and the user device. Next, at block 404, data being transmitted from the data source to the user device is received. Next, at block 406, it is determined if the at least one condition is satisfied. Next, at block 408, the new content is injected into the data if the at least one condition is satisfied. The type of content to be injected may be selected by the content injection service user while configuring the configuration information. Next, at block 410, the data including the new content is sent to the user device if the at least one condition is satisfied.

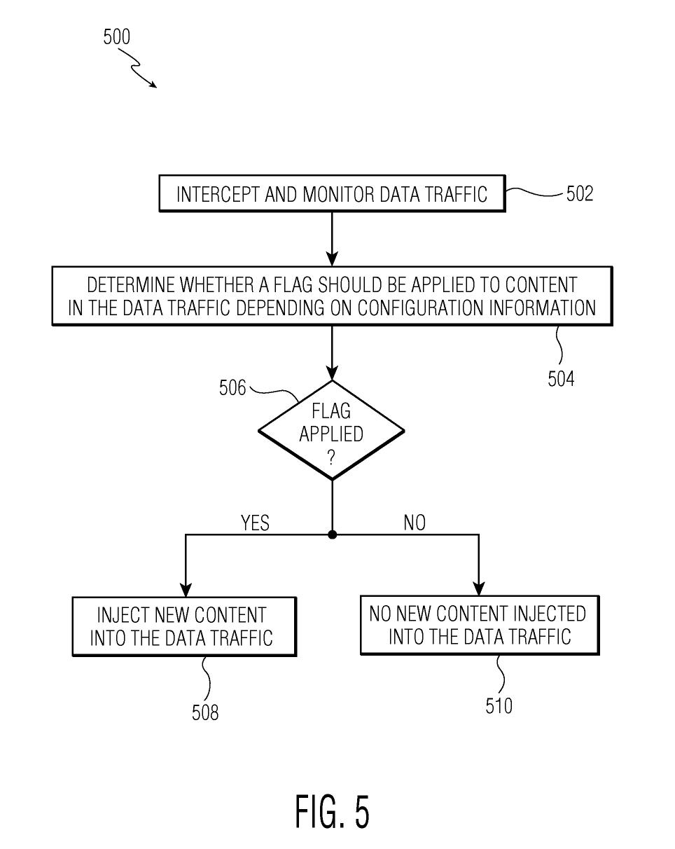

A method for injecting a new content into an original content based on user configurable conditions in accordance with an embodiment of the invention is now described with reference to a flow diagram of FIG. 5. At block 502, data traffic is intercepted and monitored. Next, at block 504, based on configuration information, the method determines whether a flag should be applied for the data traffic. The configuration information is customizable and can be configured by a content injection user. In one embodiment, specific configuration information may be accessed and changed only by the content injection service user that created the specific configuration information. In another embodiment, the specific configuration information may also be accessed by a content injection user other than the content injection user that created the specific configuration information. Access restriction to configuration information may, for example, be based on user authentication. Next, at decision block 506, it is determined whether the data traffic is flagged. If the data traffic is flagged, the flowchart continues to block 508, where new content is injected into the data traffic. If the data traffic is not flagged, the flowchart continues to block 510, where no new content is injected into the data traffic, and the original data traffic may be forwarded to a destination device.

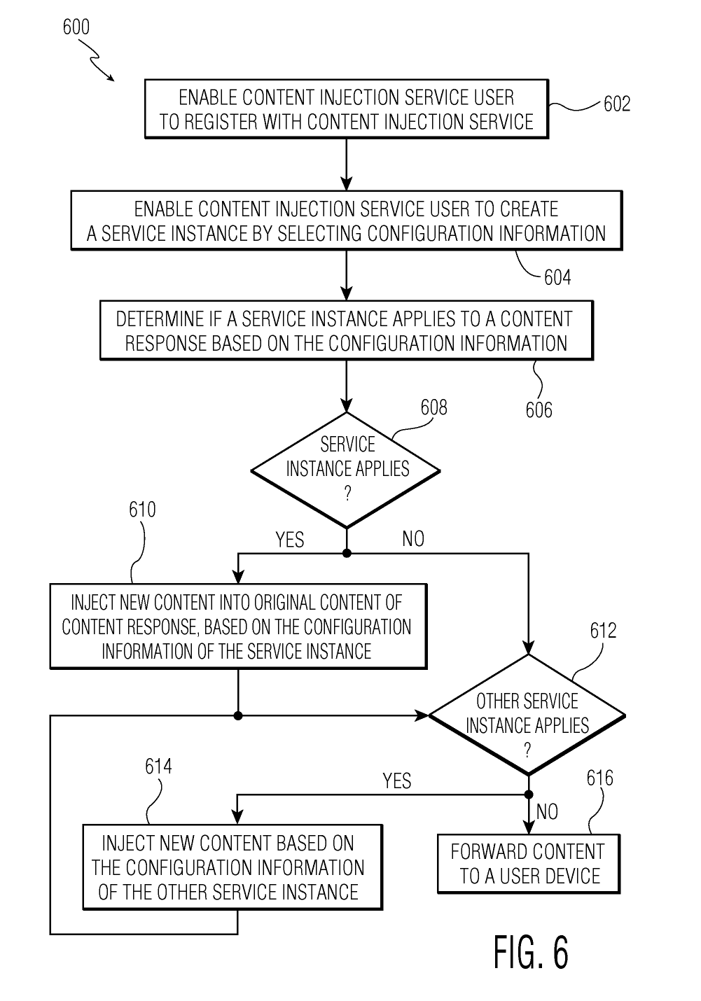

A method for allowing a content injection service user to control content injection in accordance with an embodiment of the invention is now described with reference to a flow diagram of FIG. 6. At block 602, a content injection service user is enabled to register with a content injection service. Next, at block 604, the content injection service user is enabled to create a service instance by selecting configuration information. More than one service instance may be created for the content injection service, and more than one content injection service user may be allowed to create service instances. Next, at block 606, based on the configuration information of the service instance, the method determines if a service instance applies to a content response. Next, at block 608, if the service instance applies to the content response the flowchart continues to block 610 where new content is injected into the original content of the content response. The new content is given by the configuration information of the service instance. The flowchart then continues to block 612, where it is determined if other service instances apply to the content response. The decision may be based on conditions given by the configuration information of the other service instances. Additionally, the decision may be based on conflict resolution, for example if insertion of another new content given by the other service instance would interfere with the insertion of the new content given by the initial service instance. If the decision block 612 determines that another service instance applies, the flowchart continues to block 614, where another new content based on the configuration information of the other service instance is injected into the content response. The flowchart then continues to block 612. If the answer at decision block 608 is no, the flowchart continues to block 612. If the answer at decision block 612 is no, the flowchart continues to block 616 where the content response is forwarded to a user device. The forwarded content response may include one or more new contents, based on the decisions at blocks 608 and 612.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A content injection service system comprising:
a configuration module configured to enable content injection service users to set configuration information, said configuration information including at least one condition related to data traffic between a data source and a user device;
a management module configured to monitor data of said data traffic, said management module further configured to determine if said at least one condition is satisfied; and
a content injector operatively connected to said management module, said content injector configured to inject a new content into said data in response to said at least one condition being satisfied such that said data and said new content are transmitted to said user device if said at least one condition is satisfied.

2. The content injection service system of claim 1, wherein said data includes an original content, and wherein said content injector is configured to inject said new content into said original content if said at least one condition is satisfied.

3. The content injection service system of claim 1, wherein said configuration module is configured to be accessed using a web browser for said content injection service users to set said configuration information.

4. The content injection service system of claim 1, wherein said data source is an origin server, and wherein at least one of the content injection service users is an owner of the origin server.

5. The content injection service system of claim 1, wherein the content injection service user is a third party with respect to said data source and said user device.

6. The content injection service system of claim 1, wherein said data includes a markup language file, and wherein said content injector is configured to inject said new content into said markup language file if said at least one condition is satisfied.

7. The content injection service system of claim 6, wherein said new content is scripting language characters or markup language characters, and wherein said content injector is configured to inject said scripting language characters or said markup language characters into said markup language file.

8. The content injection service system of claim 6, wherein said markup language file is an HTML file and said new content is a JavaScript, and wherein said content injector is configured to inject said JavaScript into said HTML file.

9. The content injection service system of claim 1, wherein said at least one condition is related to at least one of the device type of said user device, the time when said data is received at said management module, the subscription plan of said user device and the universal resource locator (URL) associated with said data.

10. The content injection service system of claim 1, wherein said content injector is part of an Internet proxy and wherein said management module is a plan management module of said Internet proxy.

11. A method of injecting a new content into data of a data traffic between a data source and a user device, the method comprising:
receiving configuration information configured by a content injection service user, said configuration information including at least one condition related to said data traffic between said data source and said user device;
receiving said data being transmitted from said data source to said user device;
determining if said at least one condition is satisfied;
injecting said new content into said data if said at least one condition is satisfied; and
sending said data including said new content to said user device if said at least one condition is satisfied.

12. The method of claim 11, wherein said data includes an original content, and wherein said injecting includes injecting said new content into said original content if said at least one condition is satisfied.

13. The method of claim 11, wherein said receiving said configuration information includes receiving said configuration information from a web browser being used by said content injection service user to set said at least one condition.

14. The method of claim 11, wherein said data source is an origin server, and wherein at least one of the content injection service users is an owner of the origin server.

15. The method of claim 11, wherein the content injection service user is a third party with respect to said data source and said user device.

16. The method of claim 11, wherein said data includes a markup language file, and wherein said injecting includes injecting said new content into said markup language file if said at least one condition is satisfied.

17. The method of claim 16, wherein said new content is scripting language characters or markup language characters, and wherein said injecting includes injecting said scripting language characters or said markup language characters into said markup language file.

18. The method of claim 16, wherein said markup language file is an HTML file and said new content is a JavaScript, and wherein said injecting includes injecting said JavaScript into said HTML file.

19. The method of claim 11, wherein said at least one condition is related to at least one of the device type of said user device, the time when said data is received at said management module, the subscription plan of said user device and the universal resource locator (URL) associated with said data.

20. A content injection service system comprising:
a configuration module configured to enable content injection service users to set configuration information, said configuration information including at least one condition related to data files being transmitted between a data source and a user device;
a management module configured to monitor said data files being transmitted between said data source and said user device, said management module further configured to determine if said at least one condition is satisfied; and
a content injector operatively connected to said management module, said content injector configured to inject a script into at least some of said data files in response to said at least one condition being satisfied such that said at least some of said data files with said script are transmitted to said user device if said at least one condition is satisfied.
